(19) United States
(12) Patent Application Publication
(10) Pub. No.: US 2013/0066793 A1
(43) Pub. Date: Mar. 14, 2013

(54) Winrows

(71) Applicants: Durand Kevin Dickerson, Leavenworth, KS (US); Lawrence Derwood Kenemore, Leavenworth, KS (US)

(72) Inventors: Durand Kevin Dickerson, Leavenworth, KS (US); Lawrence Derwood Kenemore, Leavenworth, KS (US)

(21) Appl. No.: 13/199,870

(22) Filed: Sep. 12, 2011

(51) Int. Cl. G06Q 99/00; B65F 1/00; B65F 3/00; B09B 3/00

(52) U.S. Cl. 705/317; 588/300; 588/405

(57) ABSTRACT

Winrows is a specific process which executes in synergy with Fill-A-Box©™ and Stat-Medicament-Disposal(c)™ removal of food waste (bio-waste) from landfills and water systems.

It quantifies data by address/location by weight of food waste (bio-waste) that is then converted under cap and trade to carbon off-set credits for address/location through Greenebank(c)™.

It is a converted 13 gallon collapsible garbage holder that has been modified to hold extra bags and a carbon filter.

The food waste (bio-waste) is used in vermiculture, and composting. The liquid by-product and final product is harvested and sold and any excess is converted to swill for pig feed.

Curbside pickup by Fill-A-Box©™ scans and weighs the bags and transmits data to Winrows database by address/location.

### PROCESS SPECIFICATION

A portion of the disclosure of this patent document contains material which is subject to copyright protection. The copyright owner has no objection to the facsimile reproduction by anyone of the patent document or the patent disclosure as it appears in the patent and trademark office patent file records, but otherwise reserves all copyright rights whatsoever.

### SUMMARY OF THE INVENTION

The object of this invention is the-collection of kitchen food waste (bio-waste) to include: beef, pork, chicken, fish, (without bones), milk, eggs (including shells), cheese (all dairy products), juices, yogurt, breads, pastries, cakes, fruits, vegetables, in the Winrows collection system. This efficiently removes kitchen food waste (bio-waste) from landfills and water systems.

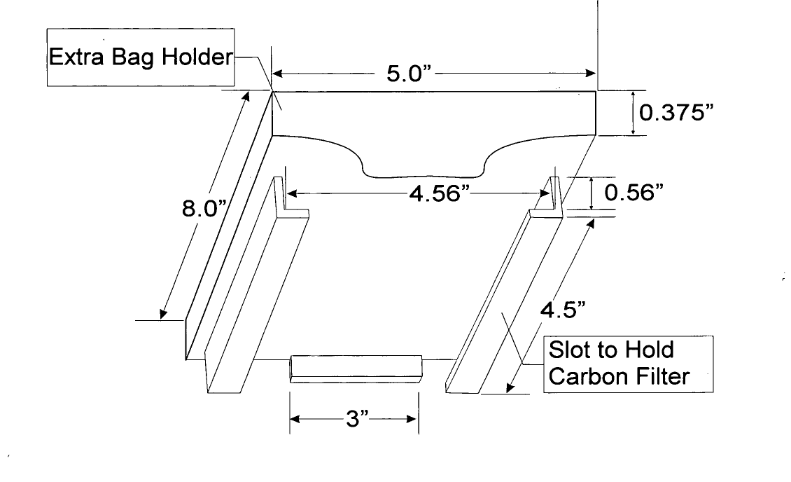

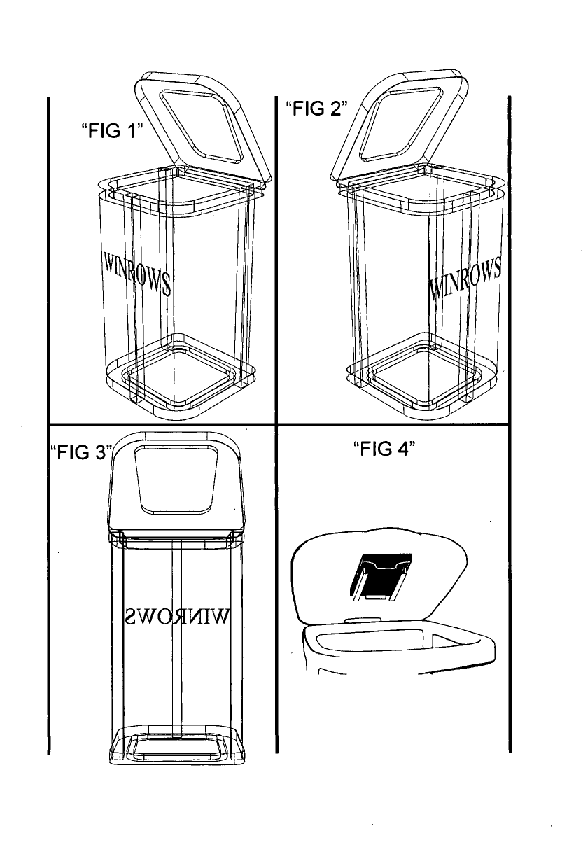

Page-9 FIGS. 1, 2, and 3 shows the Winrows collection system which consists of a common 13 gallon collapsible garbage bag holder which has been modified. FIG. 4 shows modification to the inside of the lid of a common 13 gallon collapsible garbage bag holder. Please see Drawings 1 of 2 and 2 of 2 page 7 and 8.

The compact size of the common 13 gallon collapsible garbage bag holder, along with the carbon filter for odor control and the printing on the bag, is a constant reminder to recycle these items on a daily basis.

Pick up of the Winrows bags will be achieved at the same time as the Fill-A-Box©™ patent Ser. No. 12/658,460, which achieves a one-stop recovery of Household Hazardous Waste and kitchen food waste (bio-waste).

The Winrows collection system Page-9, FIGS. 1, 2, 3 and 4 will produce a verifiable weight of kitchen food waste (bio-waste) through claims 1 through 7 in synergy with Fill-A-Box©™ by address/location.

The Winrows collection system Page-9, FIGS. 1, 2, 3, and 4 claims 1 through 7 produces verifiable reports by City, County, State of the actual amount removed from the landfill and water systems.

The kitchen food waste (bio-waste) will then be used in Winrows Worm Farm producing vermiculture and the composting operation will produce compost the excess kitchen food waste (bio-waste) not able to be used in Winrows Worm Farm will be treated by the steam generated from Stat-Medicament-Disposal©™ to raise the temperature to 1,600° which will then allow the kitchen food waste (bio-waste) to be used in swilling (pig feed).

The amount of kitchen food waste (bio-waste) collected and weighted will be converted to cap and trade saleable credits through Greenebank©™ (patent pending) accounts.

### BRIEF DESCRIPTION OF THE DRAWINGS

This invention will now be examined in greater detail by way of reference to the accompanying drawings 1 of 2, 2 of 2 wherein:

Drawings 1 of 2 shows an extra garbage bag holder and holder for a carbon filter which is 5.0″ by 8.0″ by 0.375″ deep, which is the holder for the extra garbage bag attached to the bottom of the top of the common 13 gallon garbage bag collapsible holder by rivets and there are two slide slots 4.5″ long 0.56″ deep with a backstop to keep a carbon filter from sliding out when the lid is raised.

Drawings 2 of 2 is a drawing of the garbage bag holder and carbon filter holder attached to a common 13 gallon collapsible garbage bag holder lid.

### DESCRIPTION OF PREFERRED EMBODIMENTS

Page-9 FIGS. 1, 2, 3 and 4 designates a common 13 gallon collapsible garbage bag holder. This holder has a bottom support and side supports with clips on the rim that serve to hold the bag in place with a hinged lid that has been modified pursuant to drawings 1 of 2 and 2 of 2.

Drawings 1 of 2 and 2 of 2 designate the modification to the lid, of the common 13 gallon collapsible garbage bag holder. This modification is for an extra garbage bag holder and slots to slide a carbon filter for odor control. Drawings 1 of 2 is attached to the underside of the lid of the common 13 gallon collapsible garbage bag holder by rivets.

The outside of drawings 1 of 2 and 2 of 2 is stenciled “EXTRA BAGS”. For additional bags call us at 913-351-2919 or email us at contact@winrows.org.

Drawings 2 of 2 shows the lid of common 13 gallon collapsible garbage bag holder on the underside at the front will be stenciled: REMOVE THE FILTER EVERY 30 DAYS AND PLACE IN THE SUN TO RECHARGE. FOR A REPLACEMENT PLEASE CALL: 913-351-2919 or e-mail us at contact@winrows.org.

Page-10 the specific printing that is printed on two (2 sides) of the garbage bag.

I claim,

1. A method of collection and recycling of kitchen food waste (bio-waste). This is achieved by way of a common 13 gallon collapsible garbage bag holder, which has been modified. This modification is depicted in Drawings 1 of 2 and 2 of 2, with specific printing on the bag, as shown on Page-10. This common 13 gallon collapsible garbage bag holder (Winrows) as modified is placed at an address/locations for the collection and disposal of kitchen food waste (bio-waste). The Winrows collection system separates this kitchen food waste (bio-waste) from (HHW). It is removed from the water system and landfill by curbside pick-up through a synergy with Fill-A-Box patent Ser. No. 12/658,460 at the same time as Fill-A-Box©™ is picked up. The Winrows bag has a barcode, which will be placed on it prior to delivery to the address/location. Upon pick up the bag is scanned by a bar code scanner into a PDA or WI-FI device. This weight of the curbside bag and data will be interfaced with the Fill-A-Box©™ database program assigned to that address/location where it is picked up. Upon arrival at the Fill-A-Box©™ plant, the bags will be transferred to Winrows operations.

2. Drawings 2 of 2 show the lid of a common 13 gallon collapsible garbage bag holder that has been modified. This modification is to the lid on the inside of the common 13 gallon collapsible garbage bag holder. This modification adds a holder for extra garbage bags that is riveted to the lid. The modification also includes the attachment of two slots with a backstop for a carbon filter for odor control.

3. Drawings 1 of 2 shows in detail the two slots attached to the extra garbage bag holder that are riveted to accommodate an activated carbon filter for older control that also has a backstop to hold the carbon filter in place when the lid is raised. Drawings 1 of 2 details the size, depth and width of the extra garbage bag holder and carbon filter holder.

4. The Winrows bag is screen printed Page-9 on two sides. The color of the bag is evergreen and the printing is black. Taped to the outside of the bag is a twist tie for closure, prior to placing at the curbside for pick up.

5. a method claimed in 1 through 4 in which a database program is used to barcode each bag prior to placement at the address/location. This barcode will identify:
A. address/location of placement of the Winrows collection system (see page-9)
B. total weight collected by address/location and date and total weight by month, quarter, and year.

6. A method claimed in claims 1 through 5, in which a database program is used by barcode/address/location. This barcode identifies week to week, month to month, and year to year the totals of methods 1 through 5 as to each barcode/address/location.

7. Winrows relates to the process, method, collections and weighing of kitchen food waste (bio-waste) that quantifies the weight collected, recycled and removed from landfills and water systems.

8. A method claimed in claims 1 through 7 which incorporate Stat-Medicament-Disposal©™ steam by-product, to steam treat the kitchen food waste (bio-waste) for use in swilling. This complies with cooking requirements, making it easy to transport and sell as pig-feed (swill).

9. A method in claims 1 through 7 which uses the kitchen food waste (bio-waste) as base for its Worm Farming (vermiculture) operations. This is achieved by using 55 gallon barrels, 4′ wide windrows or ditch windrows.

10. A method claimed in claims 1 through 9 which quantify the amount of methane gas removed from the Landfills.

11. A method claimed in claims 1 through 10 which allows crediting of cap and trade of greenhouse gas to the address/location under Greenebank©™, patent pending.

12. A method claimed in claims 1 through 9 which creates a by product of vermiculture (compost) to be sold under the Winrows name.

13. A method claimed in claims 1 through 9 which creates a by-product (liquid) which will be sold as a liquid fertilizer under the Winrows name.
